(19) United States
(12) Patent Application Publication
(10) Pub. No.: US 2014/0013862 A1
(43) Pub. Date: Jan. 16, 2014

(54) Wearable Ground Reaction Force Foot Sensor

(71) Applicant: Randall F. Lind, Loudon, TN (US)

(72) Inventor: Randall F. Lind, Loudon, TN (US)

(73) Assignee: UT-BATTELLE, LLC, Oak Ridge, TN (US)

(21) Appl. No.: 13/547,105

(22) Filed: Jul. 12, 2012

(51) Int. Cl. G01L 5/16

(52) U.S. Cl. 73/862.042

(57) ABSTRACT

Disclosed are several examples of a ground reaction force sensor for an article having an upper force plate for contacting the article, a lower force plate for contacting the ground, a vertical load cell disposed between the plates for measuring the force acting on the cell in a direction that is substantially perpendicular to the surface, a horizontal load cell disposed between the plates for measuring the force acting on the cell in a direction that is substantially parallel to the surface, and with the load cells being mounted between the plates in a configuration that is substantially insensitive to off-axis forces imposed on them for improved load cell measurement accuracies. Various other features and benefits are provided.

### STATEMENT REGARDING FEDERALLY SPONSORED RESEARCH AND DEVELOPMENT.

This invention was made with government support under Contract No. DE-AC05-000822725 awarded by the U.S. Department of Energy. The government has certain rights in the invention.

### CROSS-REFERENCE TO RELATED APPLICATIONS

None.

### THE NAMES OF THE PARTIES TO A JOINT RESEARCH AGREEMENT

None.

### BACKGROUND OF THE INVENTION

1. Field of the Invention

The present disclosure relates to force measurements and more specifically to a wearable sensor for measuring the reaction force of an article on a surface such as the ground.

2. Description of the Related Art

Gait analysis is the study of locomotion and is one method of analyzing the effects of various factors on ordinary movement. A subject's gait may be influenced by factors such as a stroke, spine misalignment, joint replacements, sports injuries, shoe fitment, and prosthetic limb fitment, among other things. With regard to prosthetic limb fitment, it's essential for a prosthetic limb to function properly once it's fitted to an amputee. In order for this to occur, the amputee's normal gait must be acquired and examined by a clinician, for use as a baseline. The normal gait cycle includes several components and an issue with one or more components may cause the amputee to compensate for improper fitment and this can increase stress on joints and tendons. The normal gait of an amputee can be determined by measuring the ground force reaction forces in the unaffected limb.

Known gait analysis devices include potentiometers for measuring the flexion or extension angle of a prosthetic device, sensors for mounting outside a shoe, instrumented insoles, and pressure sensitive mats, which the subject walks on.

Despite the teachings of the current art, a ground force reaction sensor having a low profile, low mass, and minimal influence on the normal gait of a subject is needed.

### BRIEF SUMMARY OF THE INVENTION

Disclosed are several examples of a ground force reaction sensor for use in a gait analysis of a subject. The ground may be any surface that can support the subject such as a tiled floor, a carpeted floor, a mat, a stair, or a stage for example, and the subject may be a human, an animal, or a machine (e.g., a robot).

According to an example, a ground reaction force sensor for an article such as a shoe includes: an upper force plate for contacting the article; a lower force plate for contacting the ground; a vertical load cell disposed between the plates for measuring the force acting on the cell in a direction that is substantially perpendicular to the ground; a horizontal load cell disposed between the plates for measuring the force acting on the cell in a direction that is substantially parallel to the ground, and with the load cells being mounted between the plates in a configuration that is substantially insensitive to off-axis forces imposed on them for improved load cell measurement accuracies.

### BRIEF DESCRIPTION OF THE SEVERAL VIEWS OF THE DRAWINGS

The present ground force reaction sensor may be better understood with reference to the following drawings and detailed description. The components in the drawings are not necessarily drawn to scale, emphasis instead being placed upon illustrating principles. In the drawings, like referenced numerals refer to like parts throughout the different drawings unless otherwise specified.

FIG. 1 is a perspective view of ground reaction force sensors installed on an article in accordance with an example of the present invention;

FIG. 2 is a top, perspective view of a forefoot ground reaction force sensor in accordance with the example illustrated in FIG. 1;

FIG. 3 is a top, perspective view of a heel ground reaction force sensor in accordance with the example illustrated in FIG. 1;

FIG. 4 is a partially exploded view of the forefoot ground reaction force sensor in accordance with the example illustrated in FIG. 2;

FIG. 5 is an assembled view and an exploded view of a vertical load cell and bearing assembly in accordance with an example of the present invention;

FIG. 6 is an assembled view and an exploded view of another vertical load cell and bearing assembly in accordance with another example of the present invention;

FIG. 7 is an assembled view and an exploded view of another vertical load cell and bearing assembly in accordance with yet another example of the present invention;

FIG. 8 is a partial sectional view of a vertical load cell and bearing assembly, in a first condition, in accordance with another example of the present invention;

FIG. 9 is a partial sectional view of a vertical load cell and bearing assembly, in a second condition, in accordance with an example of the present invention;

FIG. 10 is a perspective view of a horizontal load cell in accordance with an example of the present invention;

FIG. 11 is a sectional view of the horizontal load cell taken along line 11-11 of FIG. 10;

FIG. 12 is a schematic diagram of a Wheatstone bridge circuit in accordance with an example of the present invention; and

FIG. 13 is a schematic diagram of an electronics module in accordance with an example of the present invention.

### DETAILED DESCRIPTION OF THE INVENTION

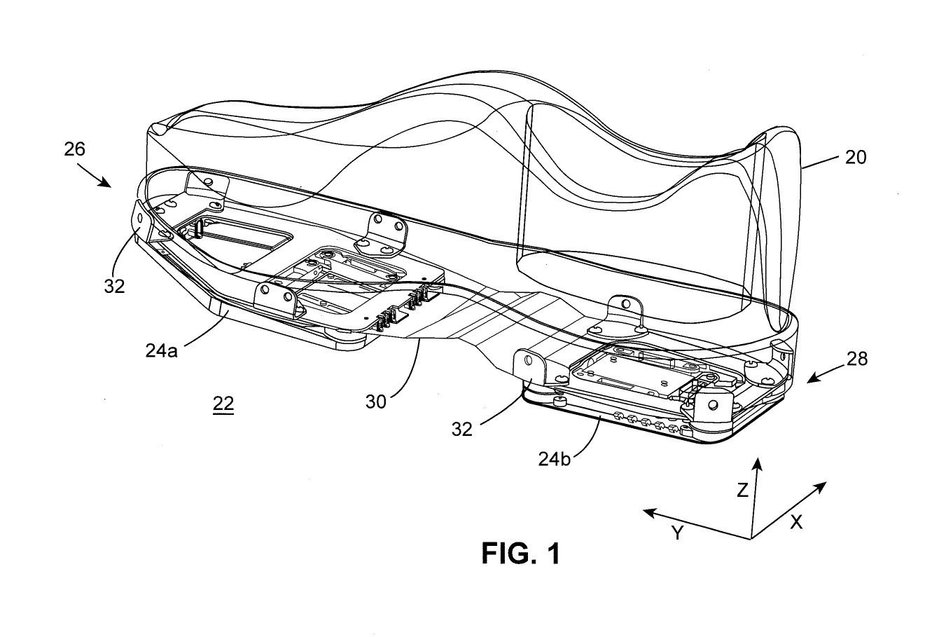

Referring first to FIG. 1, an article 20 such as a foot covering or shoe (shown), a prosthetic device, an animal's hoof, or a robotic limb, for example, transfers loads to the a surface such as the ground 22. The ground 22 extends parallel to a horizontal plane defined by an X-axis and a Y-axis. The ground 22 also extends perpendicular to first vertical plane defined by the X-axis and a Z-axis and a second vertical plane defined by the Y-axis and the Z-axis.

Exemplary ground reaction force sensors 24a, 24b may be attached to forefoot 26 and heal 28 regions at a bottom surface 30 of the article 20 by attachment means 32 such as tabs and fasteners (shown), bindings, straps, adhesives, and hook and loop fasteners, for example. In other examples, the sensors 24a, 24b are formed integrally with the article 20 during its manufacture. In yet other examples, the article 20 is modified, after its manufacture, by removing a vertical slice to compensate for the vertical thickness of the sensors 24a, 24b. Please note that the sensors 24a, 24b have a very slim vertical profile in comparison to the article 20. The forefoot sensor 24a may also be slightly curved to conform to the shape of the forefoot portion 26, thus allowing for a more natural gait by the subject during analysis.

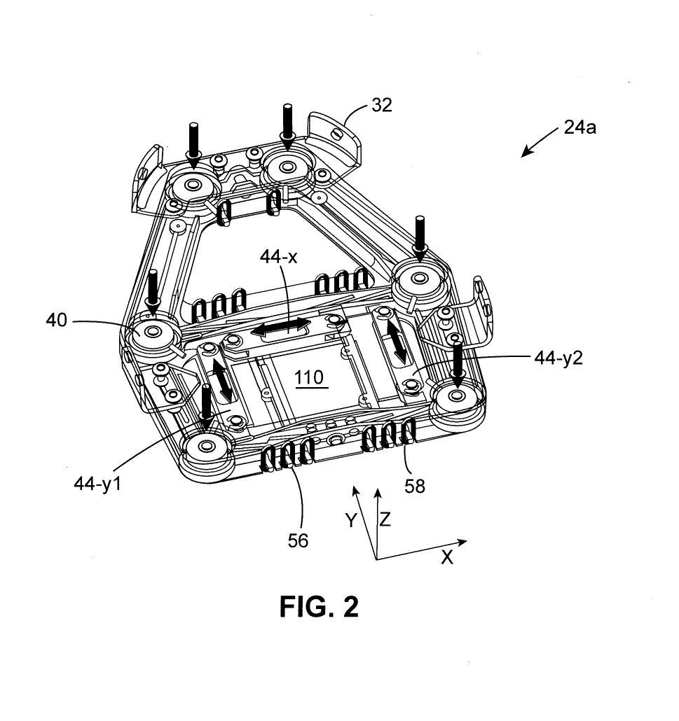

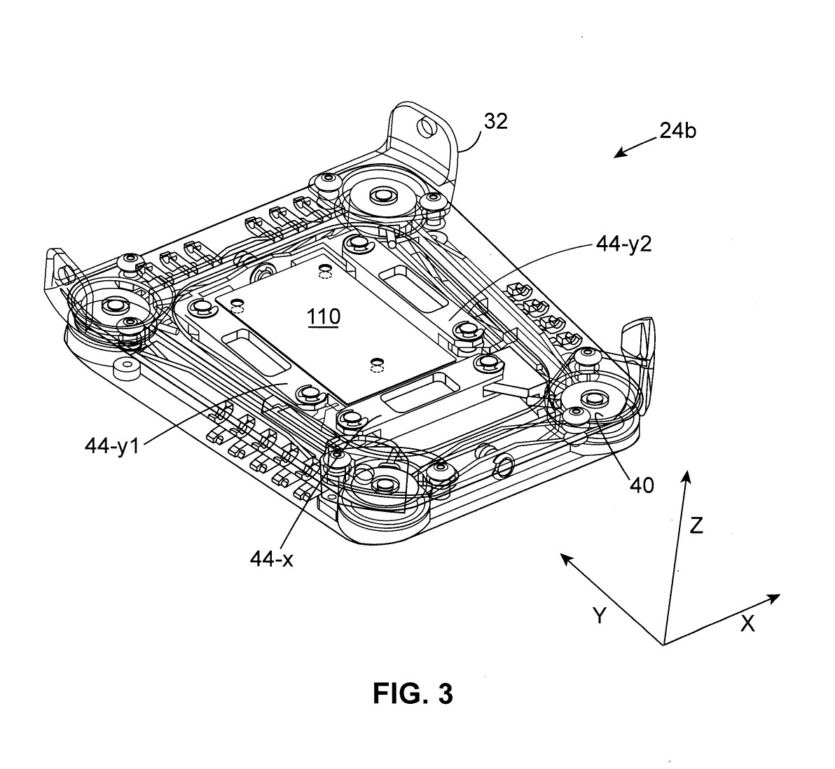

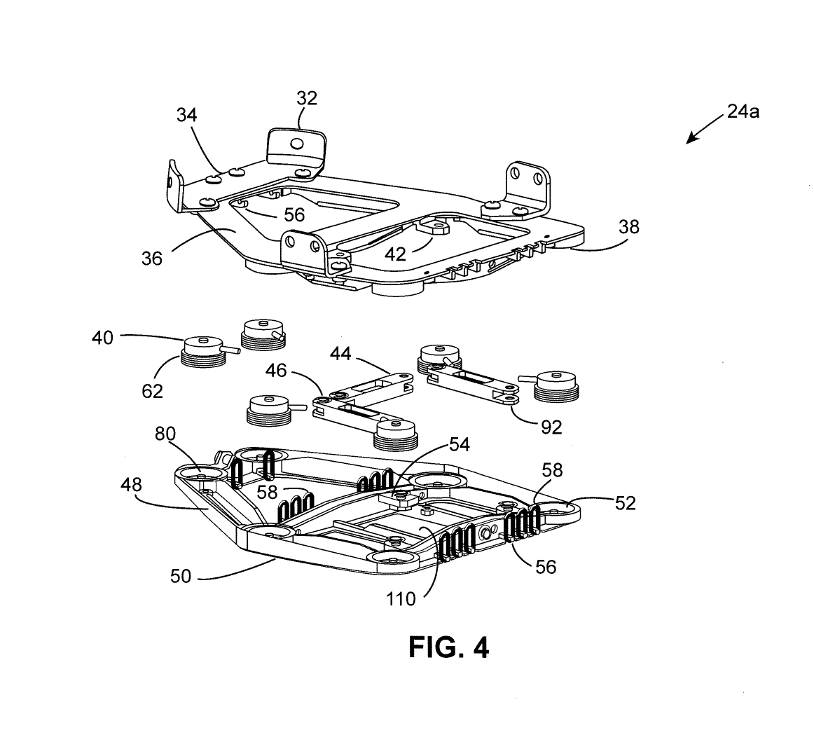

With reference to FIGS. 2-4, further details of the exemplary sensors 24a, 24b, which were designed and built at the Oak Ridge National Laboratory, will now be described in much greater detail. An upper force plate 34 includes an upper contact surface 36 for contacting the bottom surface 30 of the article 20. Upper pockets 38 receive vertical load cells 40 and upper clevises 42 receive horizontal load cells 44, which are rotationally affixed via vertically-oriented cylindrical pins 46. The pins 46 are retained by C-clips, cotter pins or other pin retention means. Please note that the upper force plate 34 includes only one upper clevis 42 for each horizontal load cell 44. In this example, three horizontal load cells were used 44-X, 44-Y1, and 44-Y2.

A lower force plate 48 includes a lower contact surface 50 for contacting the ground 22. Lower pockets 52 receive the vertical load cells 40 and lower clevises 54 receive the horizontal load cells 44, which are rotationally affixed via cylindrical pins 46 positioned vertically. Please note that the lower force plate 48 includes only one lower clevis 54 for each horizontal load cell 44.

The upper and lower force plates 34, 48 were formed using an additive manufacturing process that selectively solidifies metallic powder with an electron beam to form layers from a computer generated file, such as an STL file. In this example, the force plates 34, 48 were formed of a light-weight and high-strength Titanium Alloy using a system manufactured by Arcam AB of Gothenburg, Sweden. The force plates 34, 48 could also be formed of other light-weight and high-strength, metallic or nonmetallic, materials by stamping, forming, machining, molding, casting, or other known methods.

With the force plates 34, 48 assembled together, a horizontal load cell 44-X1 is affixed between the upper and lower clevises 42, 54 by pins 46 in a direction that is parallel to the X-axis and in the horizontal plane defined by the X-axis and the Y-axis. Additionally, two horizontal load cells 44-Y1, and 44-Y2 are affixed between the upper and lower clevises 42, 54 by pins 46 in a direction that is parallel to the Y-axis and in the horizontal plane defined by the X-axis and the Y-axis. The pins 46 assure that only substantially axial forces are transferred to the horizontal load cells 44-X, 44-Y1, and 44-Y2. By including at least three horizontal load cells 44-X, 44-Y1, and 44-Y2, the upper and lower force plates 34, 48 are inhibited from twisting and/or racking with respect to one another. Three horizontal load cells 44-X, 44-Y1, and 44-Y2, are also necessary in order to measure Fx, Fy and Mz (moment about a vertical Z-axis).

Protruding fingers 56 on each of the force plates 34, 48 retain elastomer bands 58, which secure the plates 34, 48 together and impose a slight compressive load on the vertical load cells 40. The elastomer bands 58 have a relatively low spring rate in comparison to the spring rate of the vertical load cells 40. This compressive load counteracts any potential tension loads that might occur as the upper force plate 34 is raised. The slight compressive load is simply zeroed out while processing the actual load data that is collected during the gait analysis on a computing device. An additional advantage of the elastomer bands 58 is their ability to provide unencumbered cleaning, inspection, service, and replacement of the various components of the sensors 24a, 24b.

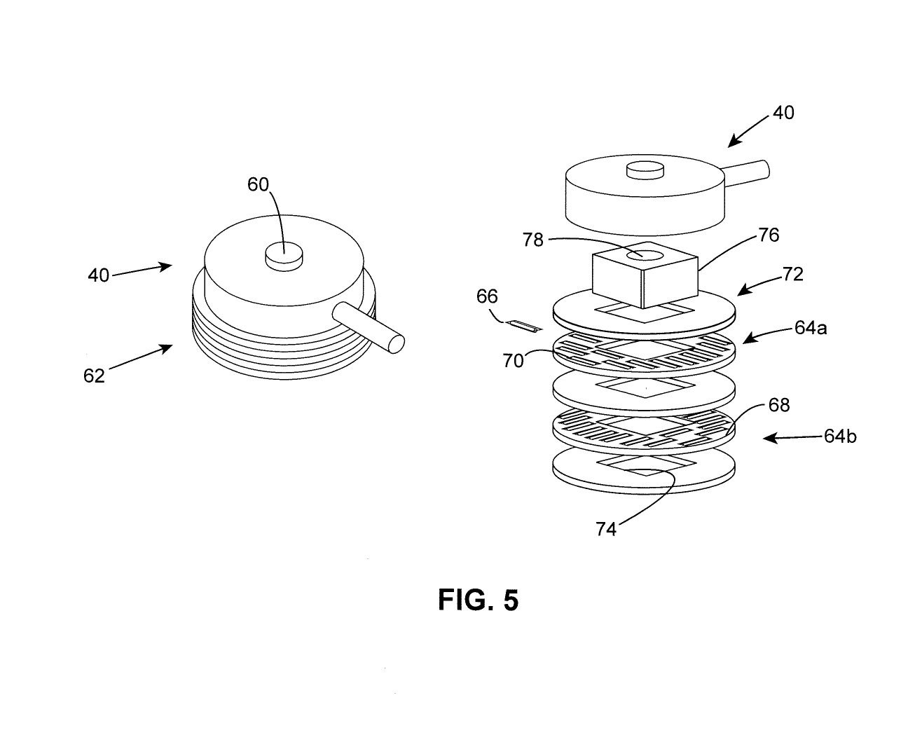

Referring now to FIGS. 5-8, further details of the vertical load cells 40 will be described. The vertical load cells 40 used in the exemplary sensors 24a, 24b are subminiature load buttons having a 250 lb (113 kg) compression load capacity, model LLB250, and sold by FUTEK Advanced Sensor Technology, Inc., City of Irvine, Calif., USA, for example. The vertical load cells 40 include a crowned surface 60 to approximate a point loading condition. This allows for slight flexing of the force plates 34, 48 with respect to each other without transmitting moment loads to the vertical load cells 40. In some examples, at least three vertical load cells 40 are used, in other examples, at least four vertical load cells 40 are used and in yet other examples, at least six vertical load cells 40 are used.

It is to be noted again that the upper force plate 34 and the lower force plate 48 are not rigidly attached to one another and that slight relative motion is necessary to measure the horizontal forces. The single axis, vertical load cells 40 are not sensitive to this off-axis loading. To ensure that the vertical load cells 40 only measure forces that are substantially perpendicular to the ground 22, a bearing assembly 62 is disposed between the vertical load cells 40 and a force plate 34, 48.

In the bearing assembly 62 example of FIG. 5, a pair of roller-type bearings 64a, 64b each include a series of individual rollers 66 confined in a cage 68 having a number of through slots 70 that are sized to accept the rollers 66. The slots 70 in the example were formed by wire EDM; however, punching, stamping, laser cutting, water jet, or other forming techniques could similarly be used. Note that all of the rollers 66 in roller-type bearing 64a are aligned in a first direction that differs from a second direction of the rollers 66 in the roller-type bearing 64b. In this specific embodiment, the rollers 66 in roller-type bearing 64a are aligned in a direction that is perpendicular to the rollers 66 of roller-type bearing 64b. This perpendicular alignment ensures that the vertical load cells 40 are substantially insulated from all lateral and fore to aft loads. A hardened bearing plate 72 (e.g., stainless steel) is disposed between the two roller-type bearings 64a, 64b. In some examples, hardened bearing plates 72 are disposed on each side of the roller-type bearings 64a, 64b (shown). Roller-type bearings 64a and 64b are available from The Timken Company, 1835 Dueber Ave., S.W. Canton, Ohio 4470-2790, USA, for example.

The two roller-type bearings 64a, 64b and the hardened bearing plates 72 may each include a clocking feature 74 that interacts with a centering element 76 made of a resilient material (e.g., 40 durometer polyurethane elastomer). In this example, a square clocking feature 74 was used; however, other clocking features (e.g., asymmetric shape, spline, slot, offset pin, etc . . . ) could also be used. The centering element 76 permits: a slight amount of unimpeded relative motion between the two roller-type bearings 64a and 64b and the bearing plates 72; permits a slight lateral movement between force plates 43 and 48; assures the two bearings 64a, 64b are orthogonal relative to each other; and assures the bearing plates 72 are concentric with one another and with the roller cages 68 after each loading cycle. The centering element 76 includes an aperture 78 for accepting a protruding pin 80 that is affixed in a pocket 38 or 52 of a force plate 34, 48. In one example, the pin 80 is affixed to the lower force plate 48 and the vertical load cell 40 contacts the upper force plate 34 (shown). In another example, the pin 80 is affixed to the upper force plate 34 and the vertical load cell 40 contacts the lower force plate 48. In another example, one of the roller-type bearings, 64a or 64b, is disposed above a vertical load cell 40 and the other of the roller-type bearings, 64a or 64b, is disposed below the vertical load cell 40.

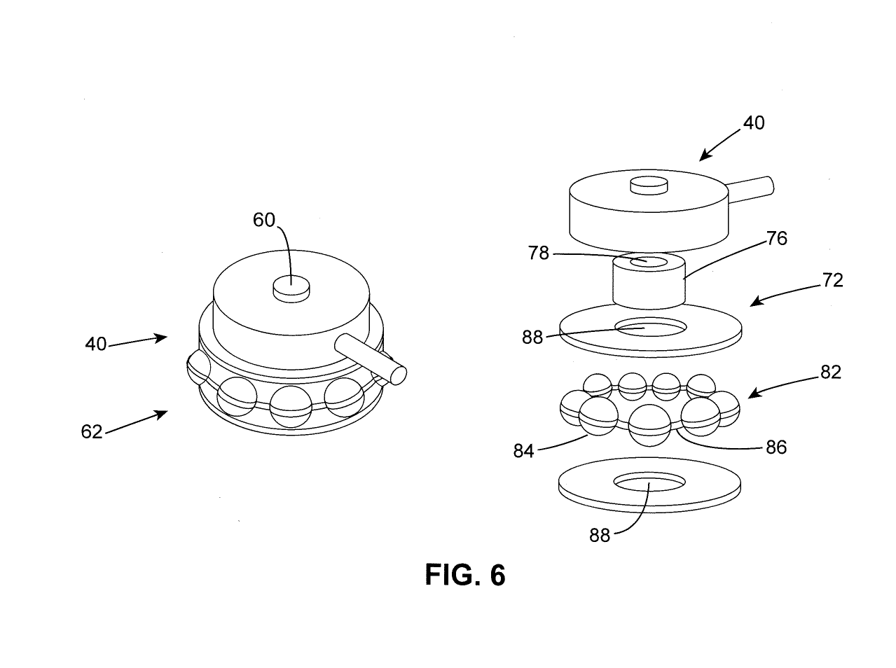

In the bearing assembly 62 example of FIG. 6, a ball-type bearing 82 includes a series of hardened steel balls 84 confined in a steel cage 86 designed for axial loading. These bearings are also known as thrust bearings. A hardened bearing plate 72 is disposed on each side of the ball-type bearing 82. The bearing plates 72 each include an aperture 88 that cooperates with a centering element 76, made of a resilient material (e.g., 40 durometer polyurethane elastomer), to ensure proper alignment of the bearing assembly 62. Please note that a clocking feature 74 is not shown in this example, because the balls 84 are free to rotate in any direction within the horizontal plane defined by the X-axis and Y-axis. Ball-type bearings 82 are available from McMaster-Carr, 200 Aurora Industrial Parkway, Aurora, Ohio 44202-8087, USA, for example.

While each type of bearing assembly 62 will work in this application, the roller-type bearings 64a, 64b provide a superior load handling capability for their size and offer a relatively low vertical profile, which enhances the function of the sensors 24a, 24b and ensures nearly unencumbered motion during gait analysis.

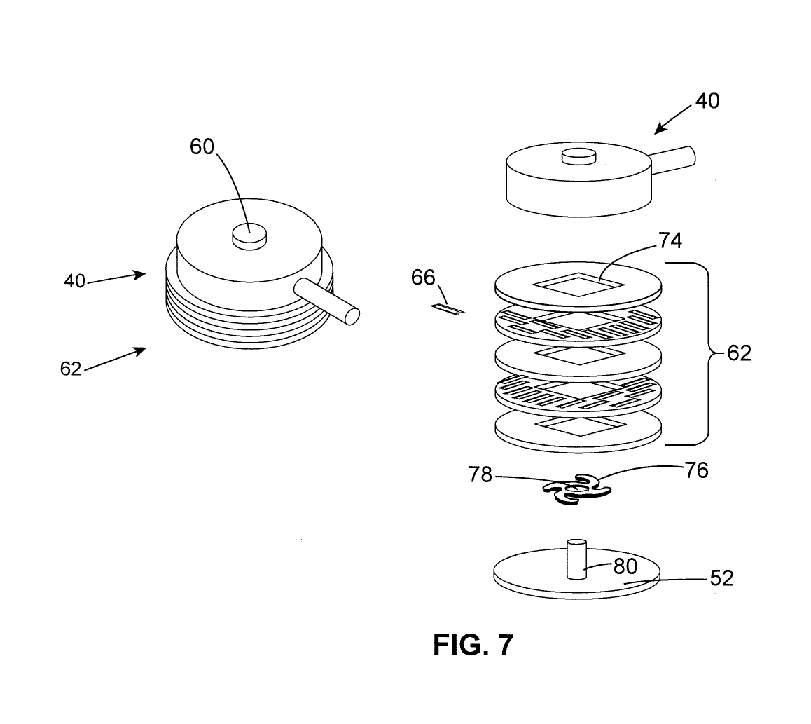

In another example of a bearing assembly 62, as illustrated in FIG. 7, an additional example of a centering element 76 is shown. In this example, the centering element has a series of compliant arms that mate with clocking features 74 as in the earlier example. An aperture 78 in the centering element 76 accepts a protruding pin 80 that is affixed in a pocket 38 or 52 of a force plate 34, 48. This centering element may be made of a resilient material (e.g., 40 durometer polyurethane elastomer); however, due to its compliant design, may also be made of a plastic or spring steel material for example. The centering element 76 permits: a slight amount of unimpeded relative motion between the two roller-type bearings 64a and 64b and the bearing plates 72; permits a slight lateral movement between force plates 43 and 48; assures the two bearings 64a, 64b are orthogonal relative to each other; and assures the bearing plates 72 are concentric with one another and with the roller cages 68 after each loading cycle.

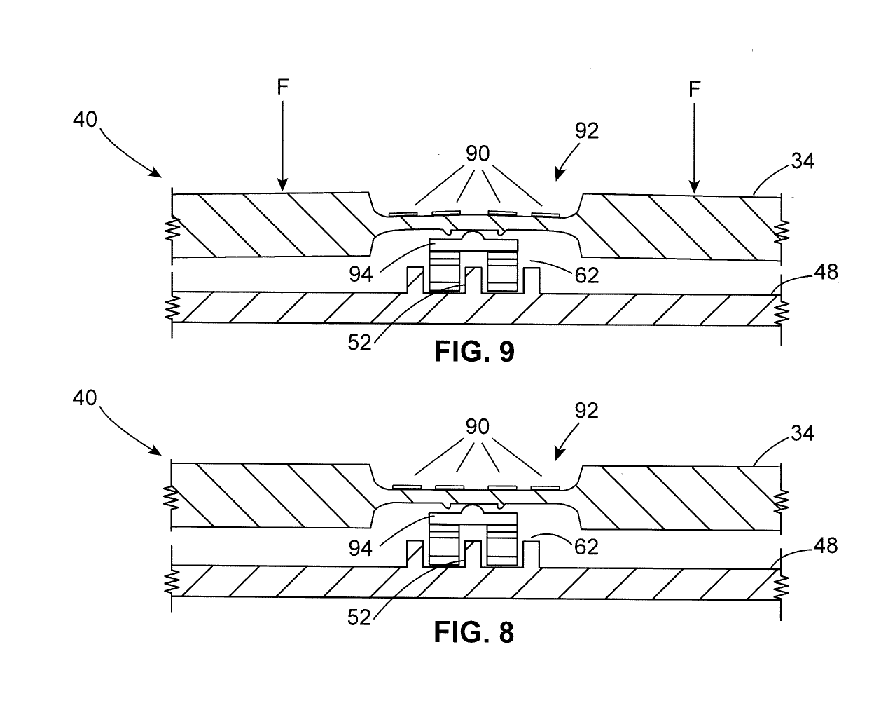

Referring now to FIGS. 8-9, another example of a vertical load cell 40 is illustrated. In this example, the vertical load cell 40 is a series of individual strain gages 90 affixed to one of the upper or lower force plates 34, 48. Here, the four individual strain gages 90 react to the deflection of a force plate 34, 48 as a force F is applied. In this example, the upper force plate 34 has a beam shaped cross sectional portion 92 that is approximately 0.020 inches (0.508 mm) thick. A crowned plate 94 sits atop a bearing assembly 62 and fits within a pocket 52, as earlier described. When a force F is applied to the load plates 34, 48, the beam portion 92 deflects slightly, as shown in the condition of FIG. 9, and the two inner strain gages 90 will be subjected to a tension load, while the two outer strain gages 90 will be subjected to a compression load. The sum of these four loads is indicative of the total vertical load on the load cell 40. In this example, the strain gages 90 are affixed directly to a force plate 34, 48, at the time of manufacture, instead of being a prefabricated component as in the earlier examples of FIGS. 5-7.

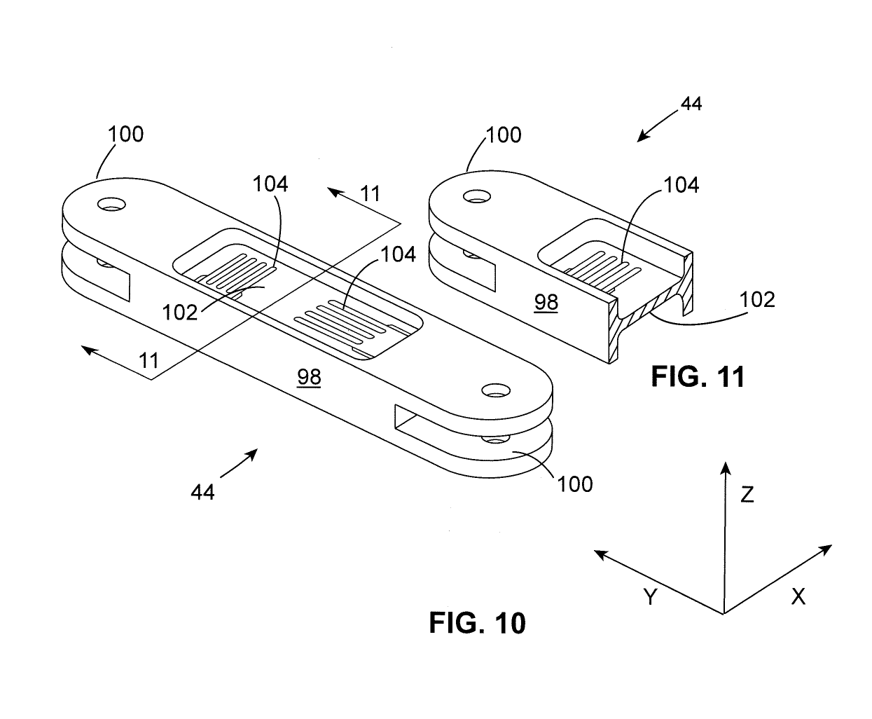

Referring now to FIGS. 10 and 11, further details of the horizontal load cells 44 will now be discussed. The horizontal load cells 44 have an I-beam shaped body 98 with clevis attachments 100 at each end for engaging clevises 42, 54 on the force plates 34, 48. In this example, the horizontal load cells 44 were machined from an aluminum alloy material, although other materials are also contemplated. A web portion 102 of the body 98 is approximately 0.020 inches (0.508 mm) thick and includes two strain gages 104 affixed on each side of the web portion 102. One strain gage 104 on each side is aligned parallel to the X-axis and one strain gage on each side is aligned parallel to the Y-axis. Strain gages 104 and associated hardware are available from Omega Engineering, Inc., One Omega Drive P.O. Box 4047, Stamford, Conn. 06907-0047, USA, for example.

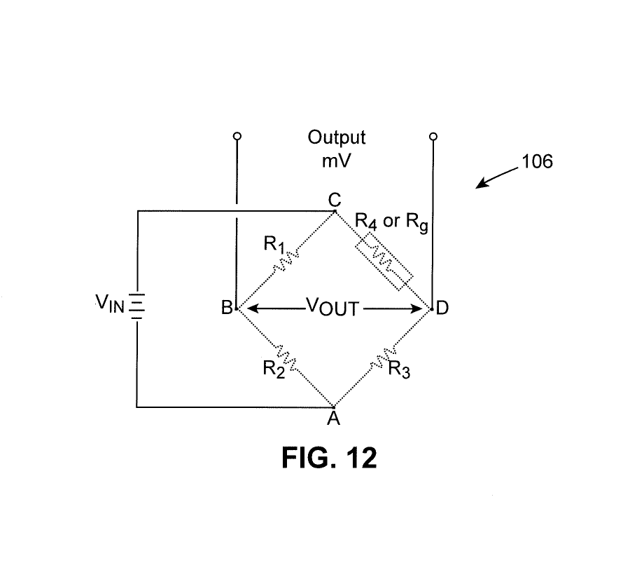

The strain gages 90, 104 are wired in a full Wheatstone bridge circuit 106 as illustrated in FIG. 12, because of its ability to measure minute resistance changes in the strain gage 90, 104 wires. The full Wheatstone bridge has two fully active strain gages in the principal stress direction and two strain gages that will see the effect of Poisson's Ratio. The full bridge circuit 106 tends to cancel thermal and off-axis errors. The output voltage of the Wheatstone bridge is expressed in millivolts output per volt input. Wheatstone bridge circuits 106 are well known in the art of strain measurements and, although this specific circuit was illustrated in the example, other circuits may also be used.

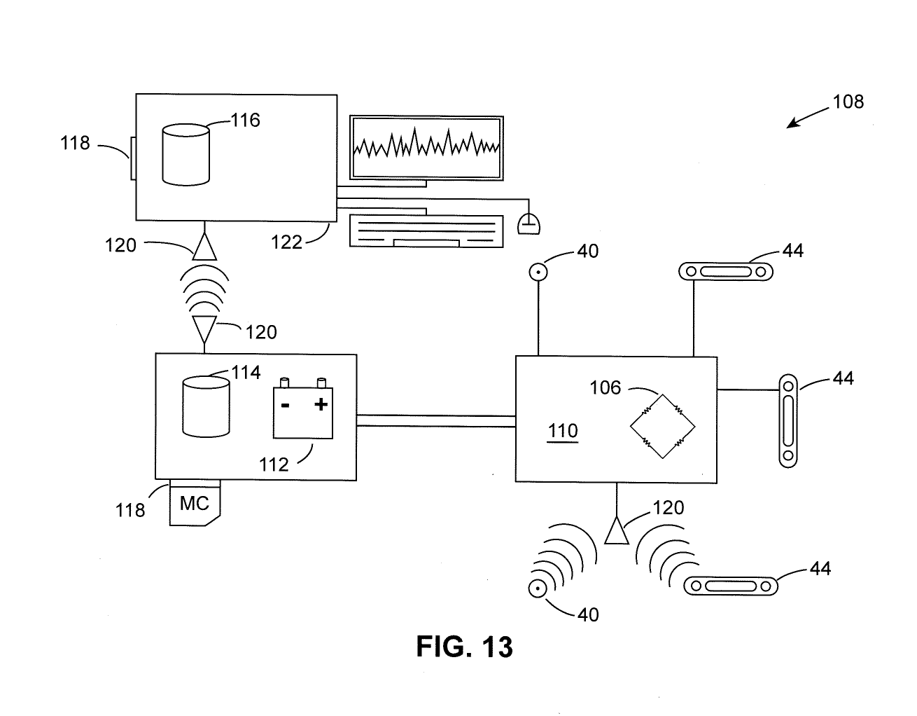

Referring finally to FIG. 13, a sensor electronics module 108 is shown. A printed circuit board (PCB) 110, located in each sensor 24a, 24b, acquires electronic signals from each of the vertical 40 and horizontal 44 load cells through directly wired or wireless connections as shown. The electronics module 108 also includes a power supply (e.g., battery) 112, and access to a local 114 and/or remote 116 data storage device. A local storage device 114 may include a hard drive, a memory card, a memory stick or other device that stores electronic load signals in the electronics module 108. A memory card slot 118 may be utilized with specialized cards and plug-in devices such as, for example, a wireless networking card, to expand the capabilities of functionality of the electronics module 108. The electronics module 108 may include a communications device 120 such as an antenna to facilitate connectivity and transfer of electronic data to the remote storage device 116 via one or more communication protocols such as: WiFi (WLAN); Bluetooth or other personal area network (PAN) standard; cellular communications; an infrared (IR) for communication via the Infrared Data association (IrDA) standard and/or any other communication standard known or yet to be developed. Once the acquired load data is communicated to and stored on the local 114 or remote 116 data storage device, it may be reviewed, manipulated, and further analyzed by a gait clinician using commercially available or custom coded software using, for example, a personal computing device 122.

While this disclosure describes and enables several examples of a wearable ground reaction force foot sensor, other examples and applications are contemplated. Accordingly, the invention is intended to embrace those alternatives, modifications, equivalents, and variations as fall within the broad scope of the appended claims. The technology disclosed and claimed herein may be available for licensing in specific fields of use by the assignee of record.

What is claimed is:

1. A wearable ground reaction force sensor for an article comprising:
an upper force plate for contacting a bottom surface of the article;
a lower force plate for contacting the ground;
a vertical load cell disposed between said plates for measuring a force acting on the cell in a direction that is substantially perpendicular to the ground;
a horizontal load cell disposed between said plates for measuring a force acting on the cell in a direction that is substantially parallel to the ground; and
wherein the load cells are mounted between the plates in a configuration that is substantially insensitive to off-axis forces imposed on them for improved load cell measurement accuracies.

2. The sensor of claim 1, wherein said horizontal load cell comprises a first and a second end, and wherein the first end is affixed to said upper force plate and the second end is affixed to said lower force plate by pin and clevis attachments for providing only substantially axial loading of the horizontal load cell.

3. The sensor of claim 1, further comprising:
a bearing disposed between said vertical load cell and a force plate for assuring only substantially axial loading of the vertical load cell.

4. The sensor of claim 3, wherein said bearing is a ball-type bearing having balls in a cage.

5. The sensor of claim 3, wherein said bearing is a roller-type bearing having rollers in a cage.

6. The sensor of claim 5, wherein said bearing comprises two roller-type bearings, each of said roller-type bearings having rollers aligned in one direction in a cage, and wherein the rollers of a first of said bearings are aligned in a first direction that differs from a second direction of the rollers of a second of said bearings.

7. The sensor of claim 6, wherein the rollers of the first of said bearings are aligned in a first direction that is perpendicular to the second direction of the rollers of said second bearings.

8. The sensor of claim 7, further comprising a bearing plate disposed between said two roller-type bearings.

9. The sensor of claim 8, wherein said two roller-type bearings and said bearing plate each have a clocking feature that cooperates with a centering element to ensure that said roller-type bearings and said bearing plate start out with a correct position and permits slight relative motion between said upper and lower force plates without adding any additional loading to said load cells.

10. The sensor of claim 10, wherein said centering element is made of an elastomer material.

11. The sensor of claim 10, wherein said centering element comprises an aperture for accepting a pin that extends from a force plate.

12. The sensor of claim 11, wherein the pin extends from said lower force plate.

13. The sensor of claim 10, comprising at least three vertical load cells and at least three horizontal load cells, and wherein two of said horizontal load cells are disposed in a direction that is perpendicular to the other one of said horizontal load cells.

14. The sensor of claim 11, comprising at least four vertical load cells and at least three horizontal load cells, and wherein two of said horizontal load cells are disposed in a direction that is perpendicular to the other one of said horizontal load cells.

15. The sensor of claim 12, comprising at least six vertical load cells and at least three horizontal load cells, and wherein two of said horizontal load cells are disposed in a direction that is perpendicular to the other one of said horizontal load cells.

16. The sensor of claim 1, further comprising an elastomer band affixed to said upper and said lower force plates, said band for providing a minimal compressive force between said force plates.

17. The sensor of claim 1, further comprising means for attaching the sensor to the article.

18. The sensor of claim 1, wherein said upper and lower force plates are made of a powdered titanium material using additive manufacturing.

19. The sensor of claim 1, further comprising an electronics module for accepting electronic signals from the load cells.

20. A wearable ground reaction force sensor for an article comprising:
an upper force plate for contacting a bottom surface of the article;
a lower force plate for contacting the ground;
a vertical load cell disposed on one of said plates for measuring a force acting on the cell in a direction that is substantially perpendicular to the ground;
a horizontal load cell disposed between said plates for measuring a force acting on the cell in a direction that is substantially parallel to the ground; and
wherein the load cells are mounted between the plates in a configuration that is substantially insensitive to off-axis forces imposed on them for improved load cell measurement accuracies.
